(19) United States
(12) Patent Application Publication
(10) Pub. No.: US 2018/0178773 A1
(43) Pub. Date: Jun. 28, 2018

(54) VEHICLE BRAKE SYSTEM AND METHOD OF OPERATING

(71) Applicant: Robert Bosch GmbH, Stuttgart (DE)

(72) Inventors: Bertram Foitzik, llsfeld (DE); Hsien-cheng Wu, Novi, MI (US); Wenguang Zhou, Novi, MI (US)

(21) Appl. No.: 15/391,410

(22) Filed: Dec. 27, 2016

(51) Int. Cl. B60T 13/74; B60T 7/04; B60T 13/68; B60T 13/14; B60T 8/40

(52) U.S. Cl. CPC B60T 13/745; B60T 7/042; B60T 13/686; B60T 2270/404; B60T 8/4081; B60T 2270/82; B60T 13/14

(57) ABSTRACT

A vehicle brake system includes a brake pedal operable to receive a user input force, a master cylinder operably coupled to the brake pedal, a brake cylinder selectively coupled to the master cylinder via a hydraulic circuit, an electronically-controlled pressure generating unit distinct from the master cylinder, and a controller operable to receive a signal indicative of the user input force to the brake pedal. In a first mode, the controller is operable to actuate the electronically-controlled pressure generating unit to apply hydraulic fluid pressure to the brake cylinder according to the signal. In a second mode, the master cylinder is operable to actuate the brake cylinder, and the controller is operable to actuate the electronically-controlled pressure generating unit to supplement the master cylinder and extend a fluid volume capacity of the master cylinder.

### BACKGROUND

The present invention relates to vehicles and vehicle braking systems.

Conventional brake-by-wire braking systems normally utilize electrically powered systems to effect vehicle braking at brake cylinders. Such braking systems often include a mechanical back-up in which the master cylinder produces a limited deceleration potential dependent upon the physical configuration of the master cylinder.

### SUMMARY

In one aspect, the invention provides a vehicle brake system. The vehicle brake system includes a brake pedal operable to receive a user input force, a master cylinder operably coupled to the brake pedal to be actuated thereby, a brake cylinder selectively coupled to the master cylinder via a hydraulic circuit, an electronically-controlled pressure generating unit distinct from the master cylinder, and a controller operable to receive a signal indicative of the user input force to the brake pedal. In a first mode, the controller is operable to actuate the electronically-controlled pressure generating unit to apply hydraulic fluid pressure to the brake cylinder according to the signal. In a second mode, the master cylinder is operable to actuate the brake cylinder, and the controller is operable to actuate the electronically-controlled pressure generating unit to supplement the master cylinder and extend a fluid volume capacity of the master cylinder.

In another aspect, the invention provides a method of operating a vehicle brake system. The vehicle includes a hydraulically actuated brake cylinder. The vehicle brake system is operated in a primary brake-by-wire mode in which fluid is applied to the brake cylinder via an electronically-controlled pressure generating unit in response to depression of a brake pedal. A controller identifies that the vehicle brake system is inoperable in the primary brake-by-wire mode. Subsequent to identifying that the vehicle brake system is inoperable in the primary brake-by-wire mode, the vehicle brake system is operated in a back-up mode as follows when the brake pedal is depressed: a fluid path is opened between a master cylinder and the brake cylinder, thereby actuating the brake cylinder with the master cylinder, and the electronically-controlled pressure generating unit is actuated with the controller to extend a fluid volume capacity of the master cylinder.

In another aspect, the invention provides a vehicle brake system. The vehicle brake system includes a brake cylinder and a master cylinder operable to pressurize fluid in response to the input force. An electronically-controlled pressure generating unit is provided separate from the master cylinder and operable to selectively actuate the brake cylinder. A pedal feel simulator is operable to provide a reaction force in response to the input force. A controller is operable to actuate the electronically-controlled pressure generating unit in a brake-by-wire configuration and operable to transition the vehicle brake system from the brake-by-wire configuration to a back-up configuration. In the brake-by-wire configuration, the electronically-controlled pressure generating unit actuates the brake cylinder and the master cylinder provides pressurized fluid to the pedal feel simulator. In the back-up configuration, the master cylinder actuates the brake cylinder with a fluid addition provided by the electronically-controlled pressure generating unit to extend a fluid volume capacity of the master cylinder.

Other aspects of the invention will become apparent by consideration of the detailed description and accompanying drawings.

### BRIEF DESCRIPTION OF THE DRAWINGS

FIG. 1 is a schematic representation of a vehicle with two axles.

FIG. 2 schematically illustrates a brake system of the vehicle of FIG. 1.

FIG. 3 schematically illustrates the vehicle brake system operating in a first mode.

FIG. 4 schematically illustrates the vehicle brake system operating in a secondary mode.

FIG. 5 is a graph illustrating a relationship between pedal travel and target piston pressure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

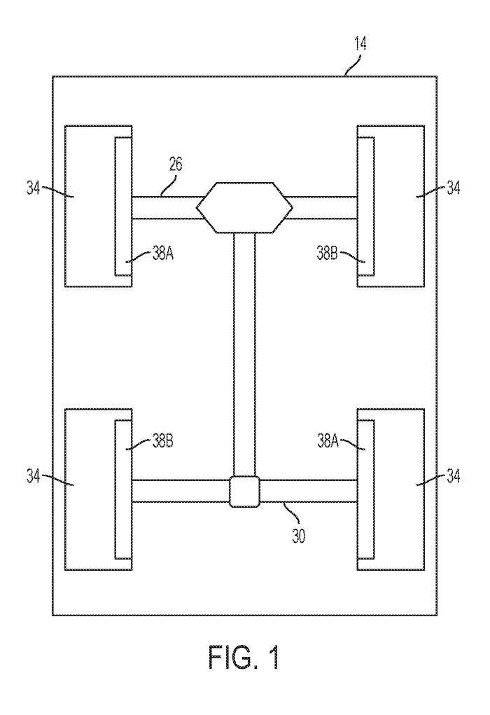

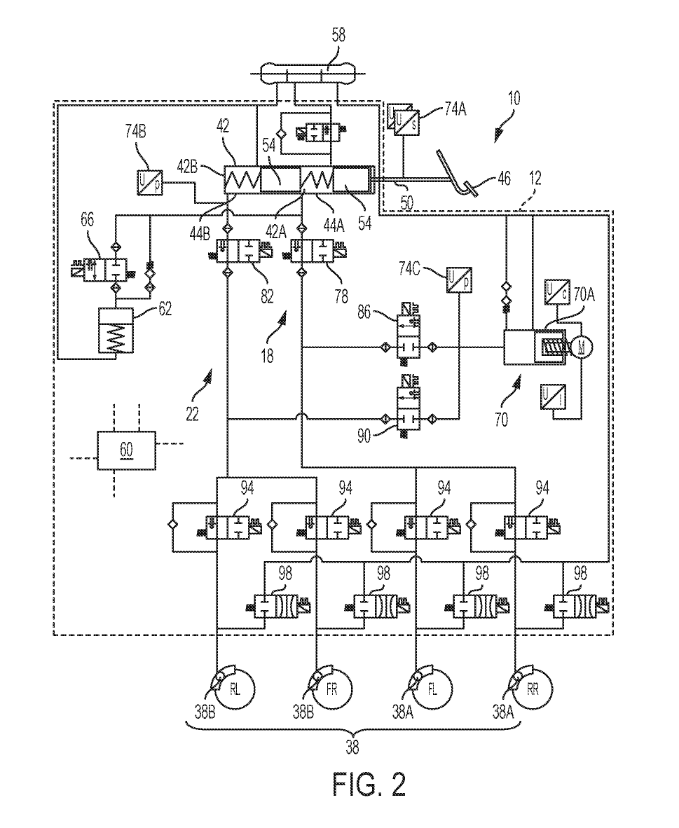

FIGS. 1-2 illustrate a vehicle 14 including a brake system 10. The brake system 10 is an integrated power braking system that incorporates a tandem master cylinder 42, a pedal feel simulator 62, an electronically-controlled pressure generating unit 70, and a group of valves (e.g., isolation and control valves 78, 82, 86, 90) into a single housing 12. Further, no booster is located between the tandem master cylinder 42 and a brake pedal 46 coupled to provide an input to the tandem master cylinder 42.

The brake system 10 includes two hydraulic circuits 18, 22, including a first hydraulic circuit 18 and a second hydraulic circuit 22. As shown in FIG. 1, the vehicle includes a front axle 26 and a rear axle 30. Each hydraulic circuit 18, 22 may provide braking to a single axle 26, 30, or may provide braking to a wheel 34 that rotates with the front axle 26, and a wheel 34 that rotates with the rear axle 30. As shown in FIG. 1 in the context of a four-wheeled vehicle, each axle 26, 30 may rotate with two wheels 34. Alternatively, each axle 26, 30 may rotate with only a single wheel 34 or more than two wheels 34. The axles 26, 30 define individual positions spaced apart in a direction of travel of the vehicle 14. A brake cylinder 38 is located at each wheel 34 and may, for example, actuate a caliper to squeeze a brake disc that is rotatable with the associated wheel 34. The first hydraulic circuit 18 provides hydraulic brake fluid to a first subset 38A of the brake cylinders 38 and the second hydraulic circuit 22 provides hydraulic brake fluid to a second subset 38B of the brake cylinders 38. As shown in FIG. 2, each subset 38A, 38B includes two brake cylinders 38. The first subset 38A includes the front left brake cylinder 38 (e.g., driver-side, front axle brake cylinder) and the rear right brake cylinder 38 (e.g., passenger-side, rear axle brake cylinder). The second subset 38B includes the front right brake cylinder 38 (e.g., passenger-side, front axle brake cylinder) and the rear left brake cylinder 38 (e.g., driver-side, rear axle brake cylinder). In an alternative embodiment, the first and second hydraulic circuits 18, 22 may provide braking to the second and first subsets 38B, 38A of brake cylinders 38, respectively. Further, it is to be understood that the relationship between directions “right” and “left” and “driver-side” and “passenger-side” is for example only, and is otherwise dependent upon the individual vehicle.

As shown in FIG. 2, a tandem master cylinder 42 is located upstream of the hydraulic circuits 18, 22 and receives a user input force via the brake pedal 46. The tandem master cylinder 42 converts the input force into hydraulic pressure within first and second master cylinder chambers 42A, 42B to produce increased hydraulic pressure within the hydraulic circuits 18, 22, respectively. More specifically, the brake pedal 46 translates a pushrod 50 and plungers 54 within the tandem master cylinder 42 to move fluid in the chambers 42A, 42B into the hydraulic circuits 18, 22 via master cylinder outlets 44A, 44B, respectively. When un-actuated, the tandem master cylinder 42 is in communication with a reservoir 58, such that the pressure within the chambers 42A, 42B is at reservoir pressure (e.g., atmospheric pressure).

The first and second circuits 18, 22 are provided with master cylinder isolation valves 78, 82, respectively. The master cylinder isolation valves 78, 82 are two-position valves, operable to transition between an open position and a closed position. Alternatively, the valves 78, 82 may be proportional valves (e.g., controlled via pulse-width modulation) such that they provide a variable flow opening ranging from a closed position to a fully open position, including a plurality of intermediate positions therebetween. When the valves 78, 82 are in the closed position, the fluid from the master cylinder chambers 42A, 42B cannot reach the brake cylinders 38 and is therefore directed towards a pedal feel simulator 62.

The pedal feel simulator 62 is located downstream of the tandem master cylinder 42 and is fluidly connected to the first circuit 18. A pedal feel simulator control valve 66 is positioned between the pedal feel simulator 62 and the tandem master cylinder 42 to selectively open or close the fluid path between the same. When in fluid communication with the tandem master cylinder 42, the pedal feel simulator 62 provides a reaction force at the brake pedal 46 in response to the force provided by the pressurized hydraulic fluid to mimic the reaction force otherwise provided when the tandem master cylinder 42 communicates directly with the brake cylinders 38.

The brake system 10 further includes an electronically-controlled pressure generating unit 70 separate from the tandem master cylinder 42. The pressure generating unit 70 provides a braking force to the brake cylinders 38 when the master cylinder isolation valves 78, 80 are in the closed position and may be mechanical, hydraulic, or mechatronic. The electronically-controlled pressure generating unit 70 has a greater fluid storage volume than the master cylinder 42 such that actuation of the pressure generating unit 70 is capable of displacing more fluid than the master cylinder 42. As shown, the pressure generating unit 70 is a motor-driven piston 70A. Alternatively, the pressure generating unit 70 may be, for example, a hydraulic accumulator or a pump. The pressure generating unit 70 produces a hydraulic pressure or output force proportional to a sensed input value. The input value may be the travel distance of the brake pedal 46 or pushrod 50, the input force provided by the user at the brake pedal 46, or the fluid pressure from the tandem master cylinder 42. Accordingly, various sensors (e.g., pedal force or travel sensor 74A, master cylinder pressure sensor 74B) measure the input value and relay the value to a controller 60. The pedal sensor 74A and the master cylinder pressure sensor 74B may be located on independent electrical circuits such that one may function as a back-up to the other. Collectively, the pedal sensor 74A and the master cylinder pressure sensor 74B can detect hard pedal issues based on a relationship between the measured fluid pressure and the force applied to or travel of the pedal 46. In turn, the pressure generating unit 70 is operated by the controller 60 to pressurize hydraulic fluid within the hydraulic circuits 18, 22 in proportion to the sensed input value.

The first and second circuits 18, 22 are further provided with pressure generating unit control valves 86, 90, respectively. The pressure generating control valves 86, 90 are two-position valves, operable to transition between an open position and a closed position. Alternatively, the valves 86, 90 may be proportional valves (e.g., controlled via pulse-width modulation) such that they provide a variable flow opening ranging from a closed position to a fully open position, including a plurality of intermediate positions therebetween. If the valves 86, 90 are in the closed position, the fluid from the pressure generating unit 70 cannot reach the brake cylinders 38.

Additional valves control the flow to and from each brake cylinder 38. Inlet valves 94 are proportional valves such that they provide a variable flow opening ranging from a closed position to a fully open position, including a plurality of intermediate positions therebetween to regulate the braking force at each brake cylinder 38 independently. Outlet valves 98 include a restrictive opening for selectively returning fluid from the brake cylinders 38 to the reservoir 58 and may, for example, assist with wheel anti-slip control.

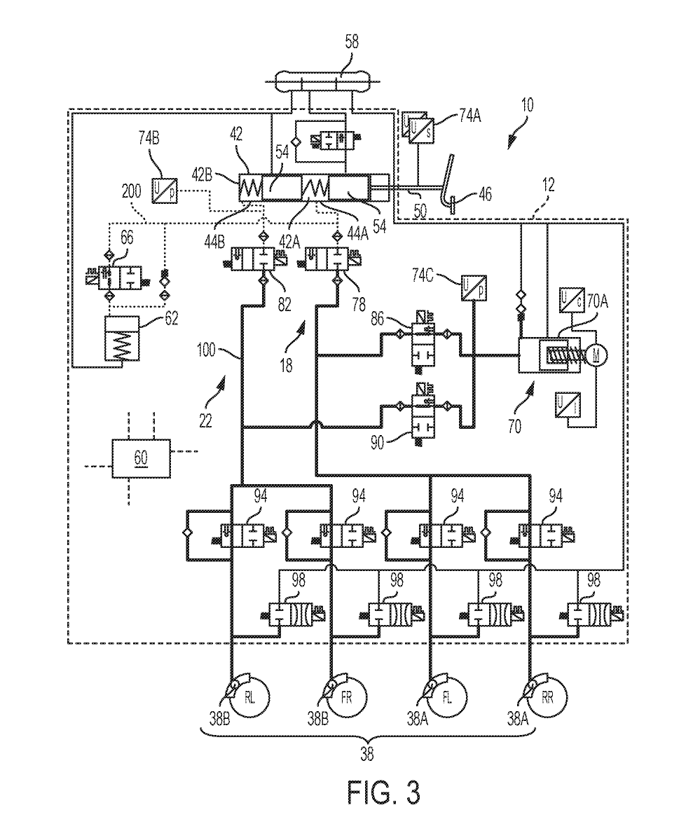

The brake system 10 is operable in a primary mode or configuration for normal brake-by-wire operation. In the primary mode, the electronically-controlled pressure generating unit 70 provides a braking force to all of the brake cylinders 38, including those in the first and second subsets 38A, 38B of brake cylinders 38. The braking force is provided in proportion to a driver's request in the normal operation, where the tandem master cylinder 42 is isolated from the brake cylinders 38 by the isolation valves 78, 82. Such braking is illustrated in FIG. 3, with the pressurized fluid from the pressure generating unit 70 illustrated with bolded lines 100 and the pressurized fluid from the tandem master cylinder 42 illustrated with dotted lines 200.

In the primary mode, the user provides an input to the brake pedal 46, which translates the pushrod 50 and plunger 54, thereby moving fluid to the hydraulic circuits 18, 22. The pedal feel simulator control valve 66 is an open position. Therefore, as indicated by dotted lines 200, the fluid pressure supplied by the tandem master cylinder 42 is provided to the pedal feel simulator 62.

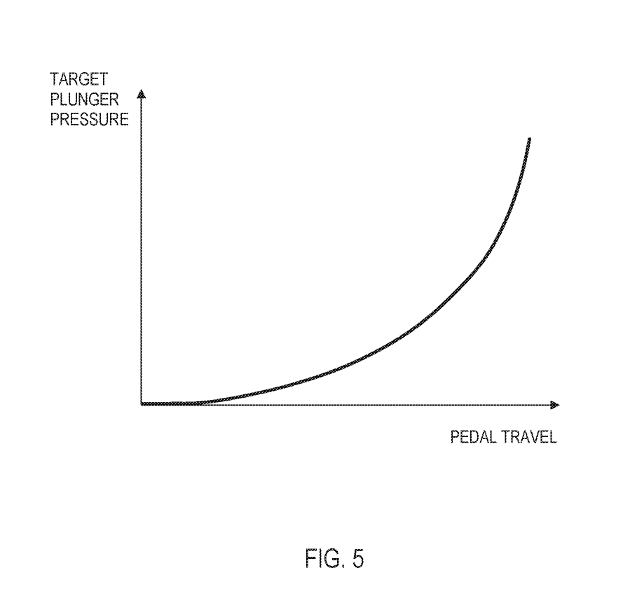

Concurrently, the pressure generating unit 70 is actuated by an output signal from the controller 60, in response to an input signal corresponding to the sensed value indicative of and proportional to the user input. The pedal travel (i.e., displacement of the brake pedal 46) is measured by the pedal travel sensor 74A and is transformed to a target piston pressure via the controller 60. The target piston pressure is associated with a specific pedal travel, for example, as shown in the graph of FIG. 5. The controller 60 converts the target piston pressure to a target motor speed and actuates a motor M (e.g., a three-phase brushless DC motor) to achieve the target motor speed. The target motor speed is variable and is adjusted with respect to time to accomplish an overall desired piston position capable of providing the target piston pressure. The piston 70A is driven by the motor M to produce increased hydraulic pressure at the brake cylinders 38 corresponding to the target piston pressure. Further, a pressure sensor 74C may measure the actual pressure of the hydraulic fluid (indicated by bolded lines 100) from the pressure generating unit 70 and provide a signal indicative of the pressure to the controller 60. The controller 60 may then compare the pressure measured by the sensor 74C to the target piston pressure. The pressure generating unit 70 may then increase or decrease the produced fluid pressure until the pressure measured by the sensor 74C matches the target piston pressure. The target piston pressure may be updated to reflect changes in the user input.

In the primary mode, the pressure generating unit control valves 86, 90 are actuated to open positions. Therefore, as indicated by bolded lines 100 in FIG. 3, the fluid pressure supplied by the pressure generating unit 70 is introduced into both the first hydraulic circuit 18 and the second hydraulic circuit 22 and is provided to the brake cylinders 38 corresponding with each. Therefore, in the primary mode, a hydraulic pressure from the pressure generating unit 70 is applied to all of the brake cylinders 38. The allowable flow rate through the control valves 86, 90 may be adjusted by the controller 60 to vary the pressure downstream of the control valves 86, 90.

Once a user removes pressure from the brake pedal 46 (e.g., removes foot from the brake pedal), the controller 60 instructs the piston 70A to return to an un-actuated state and the fluid returns to the pressure generating unit 70 via the open control valves 86, 90. The control valves 86, 90 are then returned to the closed position once fluid pressures are equalized.

The brake system 10 may transition from the primary mode to the secondary or back-up mode or configuration in response to a failure or malfunction of a component, such as one of the sensors 74A-74C (e.g., a missing signal from a sensor, a measurement outside a predetermined range, etc.), the simulator 62, or the simulator valve 66. For example, a failure of the simulator 62 or simulator valve 66 may prevent a proper pedal stroke, which may be identified by the controller 60 based on an increased pressure unassociated with an increased pedal travel. In response, the controller 60 sends a signal to transition the brake system 10 from the primary mode to the back-up mode.

However, the tandem master cylinder 42 contains a limited amount of fluid (i.e., the plungers 54 are only capable of a limited travel or translation within the tandem master cylinder 42). Because the system is primarily designed for brake-by-wire operation of the primary mode, the master cylinder volume may be quite small. Therefore, when the available fluid volume is spent and the plungers 54 bottom out, the tandem master cylinder 42 is not capable of providing any further increase in braking force. Although this technique has proven effective in practice to achieve minimum standards of deceleration in a back-up mode, further improvement in braking performance can be achieved with the layered back-up mode as described below.

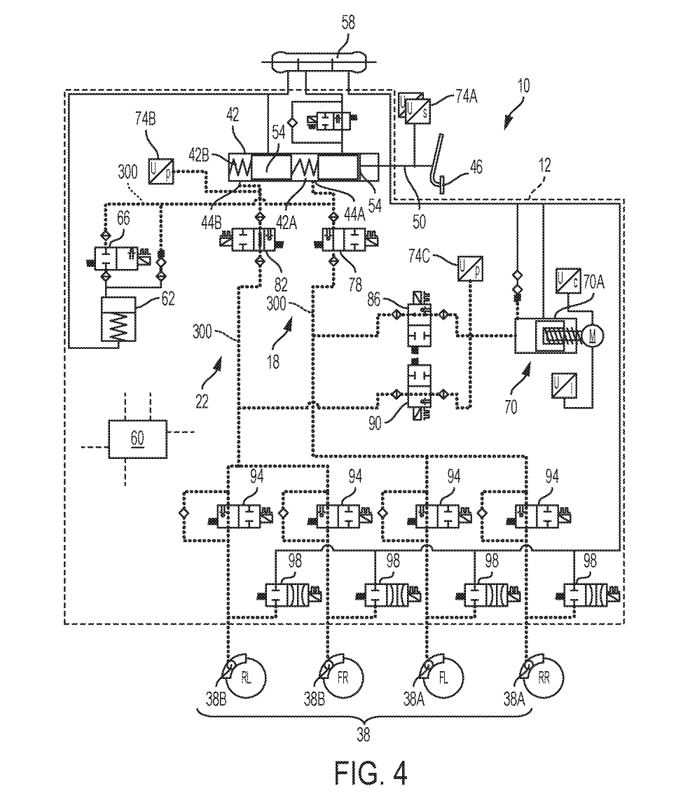

Rather than cease operation of the pressure generating unit 70 and rely on mechanical back-up solely from the tandem master cylinder 42, the secondary mode can provide a layered braking actuation, utilizing fluid from the tandem master cylinder 42 in combination with a fluid supplement from the pressure generating unit 70. In the secondary mode, as shown in FIG. 4, the user provides an input to the brake pedal 46, which translates the pushrod 50 and plunger 54, thereby moving fluid from the master cylinder chambers 42A, 42B to the hydraulic circuits 18, 22 and to all of the brake cylinders 38 through open isolation valves 78, 82. The pedal feel simulator control valve 66 is in the closed position so that fluid is not supplied from the tandem master cylinder 42 to the simulator 62.

In addition to the fluid supplied to the circuits 18,22 by the tandem master cylinder 42, the pressure generating unit 70 is actuated by the controller 60 and the control valves 86, 90 are opened to provide an additional quantity of fluid into the hydraulic circuits 18, 22, as indicated by dotted and bolded lines 300. With all of the isolation valves 78, 82 and control valves 86, 90 in open positions, the pressure generating unit 70 is in fluid communication with the brake cylinders 38 as well as the first and second master cylinder chambers 42A, 42B.

The controller 60 can actuate the pressure generating unit 70 to produce a fluid volume and/or fluid pressure value proportional to the user input to the brake pedal for addition to the hydraulic circuits 18, 22. The additional fluid is dependent upon the travel, force, or pressure measured by the sensors 74A, 74B. In other words, the pressure generating unit 70 is operated in a controlled manner to replicate or track proportionally with the input force of the driver to the brake pedal 46 as in the primary brake-by-wire mode. The layered back-up mode takes advantage of the pressure generating unit 70 to extend the ability beyond the fluid volume limitation inherent of the tandem master cylinder 42. The pressure generating unit 70, which provides brake-by-wire braking in the primary mode, functions as a volume booster for the master cylinder 42 in the back-up mode.

As the brake pedal 46 is depressed by an input force of a user, an increase in fluid volume from the pressure generating unit 70 is applied to displace the plungers 54 backwards and lift the brake pedal 46 against the user, providing additional stroke available to the user for increasing the manually-applied braking force. For example, the controller 60 may operate in a volume control mode to instruct the pressure generating unit 70 to displace a volume of fluid into the circuits 18, 22, the displaced volume dependent upon and proportional to the input force of the user. Once a user removes pressure from the brake pedal 46, the tandem master cylinder 42 returns to an un-actuated state and the controller 60 returns the piston 70A to an un-actuated state. The fluid in the circuits 18, 22 return to the pressure generating unit 70 via the open control valves 86, 90 and the tandem master cylinder 42 via the open isolation valves 78, 82.

In contrast to conventional back-up braking modes, the back-up braking mode illustrated in FIG. 4 and described above is not limited by the fluid volume of the tandem master cylinder 42. Therefore, with an equivalent master cylinder, the achievable deceleration is greater than that of a back-up braking mode which relies only on operator push-through of the master cylinder. Further, maintaining the push-through braking via the tandem master cylinder 42 to the brake cylinders 38 in both stages of the secondary mode allows the driver to directly modulate and maintain control of the total vehicle braking force.

What is claimed is:

1. A vehicle brake system comprising:
a brake pedal operable to receive a user input force;
a master cylinder operably coupled to the brake pedal to be actuated thereby;
a brake cylinder selectively coupled to the master cylinder via a hydraulic circuit;
an electronically-controlled pressure generating unit distinct from the master cylinder; and
a controller operable to receive a signal indicative of the user input force to the brake pedal;
wherein, in a first mode, the controller is operable to actuate the electronically-controlled pressure generating unit to apply hydraulic fluid pressure to the brake cylinder according to the signal, and
wherein, in a second mode, the master cylinder is operable to actuate the brake cylinder and the controller is operable to actuate the electronically-controlled pressure generating unit to supplement the master cylinder and extend a fluid volume capacity of the master cylinder.

2. The vehicle brake system of claim 1, wherein, in the second mode, the master cylinder is operable to actuate the brake cylinder proportional to the user input force.

3. The vehicle brake system of claim 1, wherein the electronically-controlled pressure generating unit is a motor-driven piston.

4. The vehicle brake system of claim 3, wherein, in the second mode, the magnitude of displacement of the motor-driven piston is dependent upon the user input force.

5. The vehicle brake system of claim 1, wherein the brake pedal is directly connected to the master cylinder without a booster therebetween.

6. The vehicle brake system of claim 1, further comprising a sensor operable to provide the signal to the controller, wherein the sensor is one of a pressure sensor, a pedal travel sensor, or a pedal force sensor.

7. The vehicle brake system of claim 1, further comprising a pedal feel simulator, wherein the master cylinder is coupled in fluid communication with the pedal feel simulator in the first mode.

8. The vehicle brake system of claim 1, further comprising an isolation valve located between the master cylinder and the brake cylinder, wherein, in the first mode, the isolation valve is closed to block a fluid path between the master cylinder and the brake cylinder, and wherein, in the second mode, the isolation valve is open to provide the fluid path between the master cylinder and the brake cylinder.

9. The vehicle brake system of claim 1, further comprising a valve located between the electronically-controlled pressure generating unit and the brake cylinder, wherein, in the first mode and the second mode, the valve is open to provide a fluid path between the electronically-controlled pressure generating unit and the hydraulic circuit.

10. The vehicle brake system of claim 1, wherein the controller is operable to transition the brake system from the first mode to the second mode in response to a signal indicative of a failure or malfunction.

11. A method of operating a vehicle brake system having a hydraulically actuated brake cylinder, the method comprising:
operating the vehicle brake system in a primary brake-by-wire mode in which fluid is applied to the brake cylinder via an electronically-controlled pressure generating unit in response to depression of a brake pedal,
identifying via a controller that the vehicle brake system is inoperable in the primary brake-by-wire mode; and
subsequent to identifying that the vehicle brake system is inoperable in the primary brake-by-wire mode, operating the vehicle brake system in a back-up mode as follows when the brake pedal is depressed:
opening a fluid path between a master cylinder and the brake cylinder, thereby actuating the brake cylinder with the master cylinder; and
actuating the electronically-controlled pressure generating unit with the controller to extend a fluid volume capacity of the master cylinder.

12. The method of claim 11, wherein, in the back-up mode, the controller operates in a volume control mode to actuate the electronically-controlled pressure generating unit to displace a volume of fluid from the electronically-controlled pressure generating unit.

13. The method of claim 12, wherein, in the back-up mode, the electronically-controlled pressure generating unit is actuated to output a fluid volume proportional to the travel of the brake pedal, dependent upon the user input force.

14. A vehicle brake system comprising:
a brake pedal operable to receive an input force
a brake cylinder;
a master cylinder operable to pressurize fluid in response to the input force;
an electronically-controlled pressure generating unit separate from the master cylinder and operable to selectively actuate the brake cylinder;
a pedal feel simulator operable to provide a reaction force in response to the input force; and
a controller operable to actuate the electronically-controlled pressure generating unit in a brake-by-wire configuration and operable to transition the vehicle brake system from the brake-by-wire configuration to a back-up configuration,
wherein, in the brake-by-wire configuration, the electronically-controlled pressure generating unit actuates the brake cylinder and the master cylinder provides pressurized fluid to the pedal feel simulator, and
wherein, in the back-up configuration, the master cylinder actuates the brake cylinder with a fluid addition provided by the electronically-controlled pressure generating unit to extend a fluid volume capacity of the master cylinder.

15. The vehicle brake system of claim 14, wherein the fluid addition provided by the electronically-controlled pressure generating unit is operable to counteract the input force.

16. The vehicle brake system of claim 15, further comprising a sensor operable to provide a signal to the controller for monitoring the input force, wherein the sensor is one of a pressure sensor, a pedal travel sensor, or a pedal force sensor.

17. The vehicle brake system of claim 14, further comprising:
a first valve located between the master cylinder and the brake cylinder;
a second valve located between the electronically-controlled pressure generating unit and the brake cylinder; and
a third valve located between the master cylinder and the pedal feel simulator,
wherein, in the brake-by-wire configuration, the first valve is in a closed position, the second valve is in an open position, and the third valve is in open position, and
wherein, in the back-up configuration, the first valve is in an open position and the second valve is in the open position.

18. The vehicle brake system of claim 14, wherein, in the back-up configuration, the magnitude of the fluid addition provided by the electronically-controlled pressure generating unit in the back-up configuration is dependent upon the magnitude of the input force.

19. The vehicle brake system of claim 14, wherein the master cylinder is operable to receive the input force, and wherein the pressure of the pressurized fluid from the electronically-controlled pressure generating unit is dependent upon the input force in the brake-by-wire configuration and the back-up configuration.

20. The vehicle brake system of claim 14, wherein the electronically-controlled pressure generating unit is a motor-driven piston.
